(19) United States
(12) Patent Application Publication
(10) Pub. No.: US 2023/0055266 A1
(43) Pub. Date: Feb. 23, 2023

(54) AIR-FRIED TYPE FOOD PROCESSOR

(71) Applicant: Shenzhen Chenbei Technology Co., Ltd., Shenzhen (CN)

(72) Inventor: Dezhi CHEN, Shenzhen (CN)

(21) Appl. No.: 17/821,774

(22) Filed: Aug. 23, 2022

(30) Foreign Application Priority Data
Aug. 23, 2021 (CN) 202110970711.1

(51) Int. Cl. A47J 37/06; A47J 36/32

(52) U.S. Cl. CPC A47J 37/0641; A47J 36/32

(57) ABSTRACT

The present invention discloses an air-fried type food processor, including: a body, which is provided with a frying barrel cavity; a frying barrel capable of being taken out of or placed in the frying barrel cavity; and an upper heating system arranged in the body and located above the frying barrel cavity, the upper heating system includes an upper heating tube and an upper heating tube support for fixing the upper heating tube, the upper heating tube has a disc-shaped spiral structure, the upper heating tube support is fixed to N pipelines on outermost rings of the upper heating tube. Deformation of a tube body of the upper heating tube is reduced, and the frying barrel is prevented from coming into contact with the upper heating tube in the process of being taken out of the frying barrel cavity or pushed into the frying barrel cavity.

### CROSS REFERENCE TO RELATED APPLICATION

This is a non-provisional application which claims priority to a Chinese patent application having an application number of CN 202110970711.1, and a filing date of Aug. 23, 2021, the entire contents of which is hereby incorporated by reference.

### TECHNICAL FIELD

The present invention relates to the technical field of food processing devices, and in particular, to an air-fried type food processor.

### BACKGROUND

At present, a heating system is provided in an air-fried type food processor, and heat of the heating system is transferred to a frying barrel by using a fan and other components, so as to cook food in the frying barrel.

However, when the air-fried type food processor is in use, a heating tube in the heating system generates heating vibration, causing a tube body of the heating tube to deform under the dual action of heating and gravity. Especially, in a structure in which the heating system is arranged above the frying barrel, the deformation of the tube body of the heating tube may even lead to a situation that the heating tube cannot be taken out of or pushed into a body of the air-fried type food processor due to contact with the heating tube a process of taking out the frying barrel, thereby affecting use.

Therefore, how to reduce deformation of the tube body of the heating tube and ensure normal use is an urgent problem to be solved by a person skilled in the art.

### SUMMARY

In view of the problem, the present invention provides an air-fried type food processor, to reduce deformation of a tube body of a heating tube and ensure normal use.

To achieve the foregoing objective, the present invention provides the following technical solution:

An air-fried type food processor includes:

a body, where the body is provided with a frying barrel cavity;

a frying barrel capable of being taken out of or placed in the frying barrel cavity; and

an upper heating system arranged in the body and located above the frying barrel cavity, where the upper heating system includes an upper heating tube and an upper heating tube support for fixing the upper heating tube, where the upper heating tube has a disc-shaped spiral structure, the upper heating tube support is fixed to N pipelines on outermost rings of the upper heating tube, and N is more than or equal to 2.

Optionally, the foregoing air-fried type food processor further includes a lower heating system arranged in the body and located below the frying barrel cavity, where the lower heating system includes a lower heating tube and a lower heating tube support fixed to the lower heating tube, and the lower heating tube support is fixed relative to the body.

Optionally, in the foregoing air-fried type food processor, the upper heating tube support includes an upper-heating-tube-support tube holder and an upper-heating-tube-support tube buckle; and

the upper-heating-tube-support tube buckle is capable of being bent relative to the upper-heating-tube-support tube holder to form a positioning space for positioning the upper heating tube.

Optionally, in the foregoing air-fried type food processor, the upper heating tube support is located on two pipelines of the outermost rings on the upper heating tube;

the upper-heating-tube-support tube holder has two mutually independent support positions; and

the upper heating tube support is provided with two independently arranged upper-heating-tube-support tube buckles,

where one of the support positions is arranged corresponding to one of the upper-heating-tube-support tube buckles, and the other support position is arranged corresponding to the other upper-heating-tube-support tube buckle.

Optionally, in the foregoing air-fried type food processor, the lower heating tube support is provided with a lower-heating-tube-support tube buckle and a lower-heating-tube-support tube holder; and

the lower-heating-tube-support tube buckle and the lower-heating-tube-support tube holder are correspondingly arranged, and a clamping space for clamping the lower heating tube is formed between the lower-heating-tube-support tube buckle and the lower-heating-tube-support tube holder.

Optionally, in the foregoing air-fried type food processor, the lower heating tube support is provided with a limiting opening portion;

an opening of the limiting opening portion faces a side edge of the lower heating tube support; and

an upper inner wall of the limiting opening portion forms a tube buckle contact surface of the lower-heating-tube-support tube buckle for being in contact with the lower heating tube, and a lower inner wall of the limiting opening portion forms a tube holder contact surface of the lower-heating-tube-support tube holder for being in contact with the lower heating tube.

Optionally, in the foregoing air-fried type food processor, where the lower heating system further includes a protective mesh arranged above the lower heating tube; and

the protective mesh is provided with a protective-mesh protection region and a protective-mesh ventilation region, where the protective-mesh protection region forms a solid shielding region corresponding to one or more pipelines of the lower heating tube, and the protective-mesh ventilation region is provided with a vent.

Optionally, in the foregoing air-fried type food processor, the lower heating system further includes a lower reflecting cover arranged below the lower heating tube;

the lower reflecting cover is provided with a concave structure which is arranged corresponding to the one or more pipelines of the lower heating tube, and a lower-reflecting-cover concave reflecting region for radiating heat of the lower heating tube upward is formed between an inner wall of the concave structure and an inner wall of the protective mesh; and

the inner wall of the concave structure is a wall surface of the concave structure facing the protective mesh, and the inner wall of the protective mesh is a wall surface of the protective mesh facing the concave structure.

Optionally, in the foregoing air-fried type food processor, the protective mesh is provided with a protective plate body located in the middle and an inclined connecting plate located at an edge of the protective plate body; and

the inclined connecting plate is inclined toward a side on which the lower heating tube is located, and is inclined downward in a direction away from the protective plate body.

Optionally, in the foregoing air-fried type food processor, the lower heating system further includes a lower cover body structure fixedly connected to inside of the body; and

the lower cover body structure includes a lower reflecting cover and a lower heat shield arranged on a side of the lower reflecting cover away from the lower heating tube, and the lower heating tube support is fixedly connected to the lower cover body structure.

Optionally, in the foregoing air-fried type food processor, the upper heating system further includes an upper cover body structure fixedly connected to the inside of the body;

the upper cover body structure includes an upper reflecting cover covering above the upper heating tube and an upper heat shield arranged on a side of the upper reflecting cover away from the upper heating tube; and

a thermal conductivity of the upper heat shield is lower than a thermal conductivity of the upper reflecting cover.

Optionally, the foregoing air-fried type food processor further includes a power box for being conductively connected with to the upper heating tube and/or the lower heating tube, where

the power box includes a power box bottom housing and a power box cover;

the power box bottom housing is internally provided with a power-box-bottom-housing interval separation rib, and the power-box-bottom-housing interval separation rib divides an inner cavity of the power box bottom housing into a power-box-bottom-housing heating tube terminal region for placing a heating tube terminal and a power-box-bottom-housing power wire region for placing a power wire; and

after the power box cover covers the power box bottom housing, the power-box-bottom-housing heating tube terminal region and the power-box-bottom-housing power wire region are mutually independent.

Optionally, in the foregoing air-fried type food processor, the upper heating system further includes an upper temperature sensor and an upper temperature protector for protecting a zero line/live line of the upper heating system; the upper temperature sensor is in communication connection with the upper heating tube, and a heating temperature of the upper heating tube is controlled according to a temperature detected by the upper temperature sensor.

Optionally, in the foregoing air-fried type food processor, the lower heating system further includes a lower temperature sensor and a lower temperature protector for protecting a zero line/live line of the lower heating system; the lower temperature sensor is in communication connection with the lower heating tube, and a heating temperature of the lower heating tube is controlled according to a temperature detected by the lower temperature sensor.

It can be learned from the foregoing technical solution that in the air-fried type food processor provided in the present invention, the upper heating system is arranged above the frying barrel cavity, so that the upper heating system heats the frying barrel in the frying barrel cavity to form a three-dimensional heating system of the air-fried type food processor, and the upper heating system can cook the front of food, that is, an upward surface of food, in the frying barrel. The upper heating tube has the disc-shaped spiral structure. Because the outer ring structure of the upper heating tube with the disc-shaped spiral structure more easily deforms downward under the action of gravity, the upper heating tube support is located on the N pipelines of the outermost rings on the upper heating tube, and as N is more than or equal to 2, a function of correspondingly binding the N pipelines on the outermost rings is achieved, thereby reducing a degree of downward deformation of the outermost rings of the upper heating tube. Through the foregoing arrangement, deformation of a tube body of the upper heating tube is effectively reduced, and the frying barrel is prevented from coming into contact with the upper heating tube in the process of being taken out of the frying barrel cavity or pushed into the frying barrel cavity, thereby ensuring that the air-fried type food processor is used normally.

### BRIEF DESCRIPTION OF DRAWINGS

To more clearly describe technical solutions in the embodiments of the present invention or in the prior art, accompanying drawings required in the description of the embodiments or the prior art are briefly described below. Obviously, the accompanying drawings in the following description illustrate only some of the embodiments of the present invention, and a person of ordinary skill in the art may further obtain other accompanying drawings from these accompanying drawings without creative efforts.

FIG. 1 is a schematic structural diagram of an air-fried type food processor provided in an embodiment of the present invention;

FIG. 2 is a first schematic sectional view of an air-fried type food processor provided in an embodiment of the present invention;

FIG. 3 is a schematic structural diagram of an air-fried type food processor provided in an embodiment of the present invention after removal of a frying barrel and a protective mesh;

FIG. 4 is a first schematic structural diagram of a frying barrel provided in an embodiment of the present invention;

FIG. 5 is a second schematic structural diagram of a frying barrel provided in an embodiment of the present invention;

FIG. 6 is a second schematic sectional view of an air-fried type food processor provided in an embodiment of the present invention;

FIG. 7 is a schematic structural diagram of an upper heating tube support provided in an embodiment of the present invention;

FIG. 8 is a schematic structural diagram of a lower heating tube support provided in an embodiment of the present invention;

FIG. 9 is a second schematic sectional view of an air-fried type food processor provided in an embodiment of the present invention;

FIG. 10 is a schematic structural diagram of an air-fried type food processor provided in an embodiment of the present invention after removal of a frying barrel;

FIG. 11 is a schematic structural diagram of a first air outlet state of a bottom housing vent provided in an embodiment of the present invention;

FIG. 12 is a schematic structural diagram of a second air outlet state of a bottom housing vent provided in an embodiment of the present invention;

FIG. 13 is a schematic structural diagram of a bottom surface of a bottom housing provided in an embodiment of the present invention;

FIG. 14 is a schematic diagram of a combined structure of a lower reflecting cover, a lower heating tube, and a lower heating tube support provided in an embodiment of the present invention;

FIG. 15 is a first schematic structural diagram of a power box bottom housing provided in an embodiment of the present invention;

FIG. 16 is a schematic structural diagram of a power box cover provided in an embodiment of the present invention;

FIG. 17 is a schematic diagram of a combined structure of a lower reflecting cover, a lower heating tube and a lower heating tube support, and a position structure of a power box provided in an embodiment of the present invention;

FIG. 18 is a second schematic structural diagram of a power box bottom housing provided in an embodiment of the present invention;

FIG. 19 is a schematic top exploded view of an air-fried type food processor provided in an embodiment of the present invention; and

FIG. 20 is a schematic bottom exploded view of an air-fried type food processor provided in an embodiment of the present invention.

### DESCRIPTION OF EMBODIMENTS

The present invention discloses an air-fried type food processor, to reduce deformation of a tube body of a heating tube and ensure normal use.

The technical solutions in the embodiments of the present invention are clearly and completely described below with reference to the accompanying drawings in the embodiments of the present invention. Clearly, the described embodiments are only some embodiments of the present invention rather than all embodiments. Based on the embodiments of the present invention, all other embodiments that are obtained by a person of ordinary skill in the art without creative efforts shall all fall within the protection scope of the present invention.

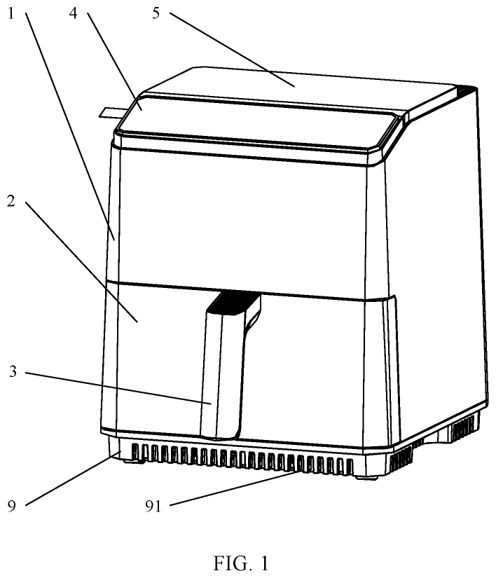

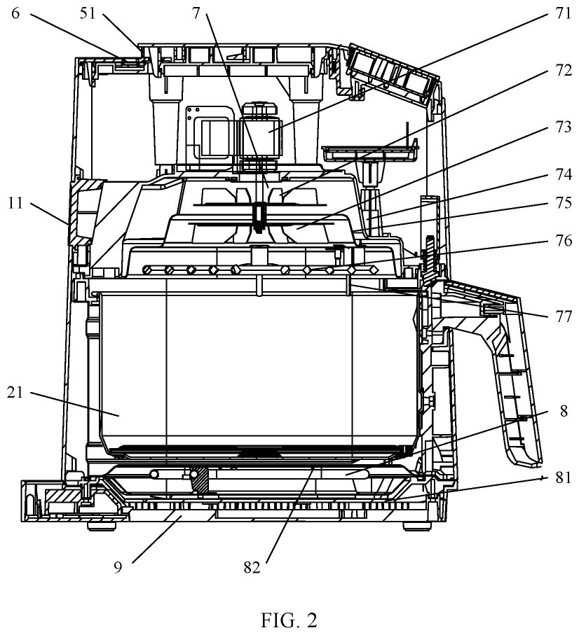

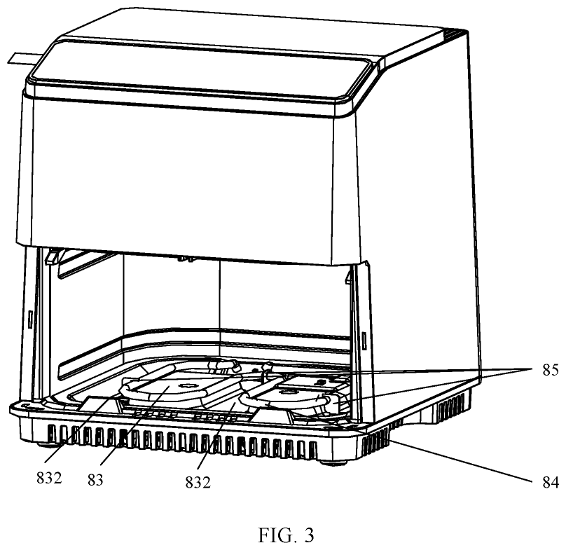

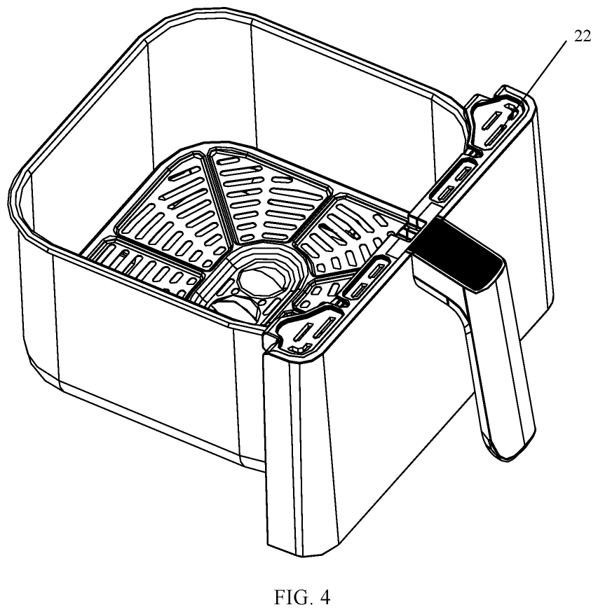

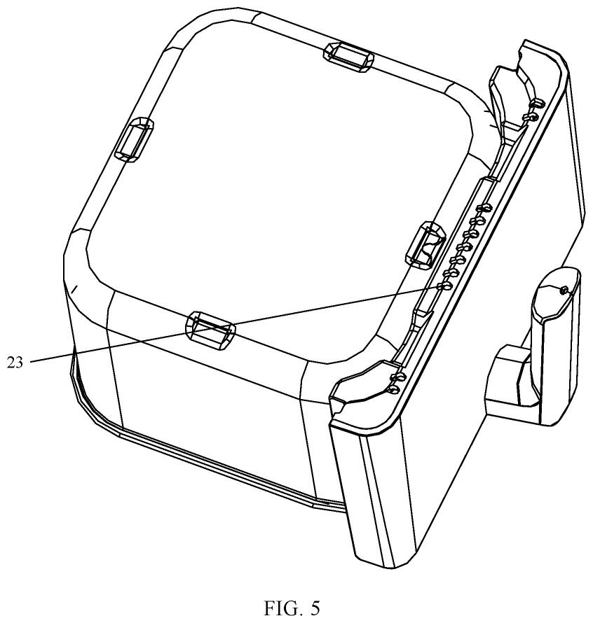

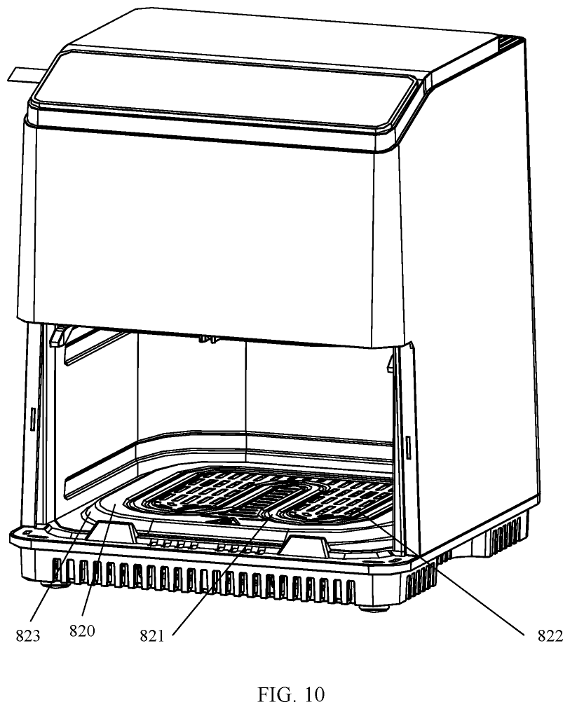

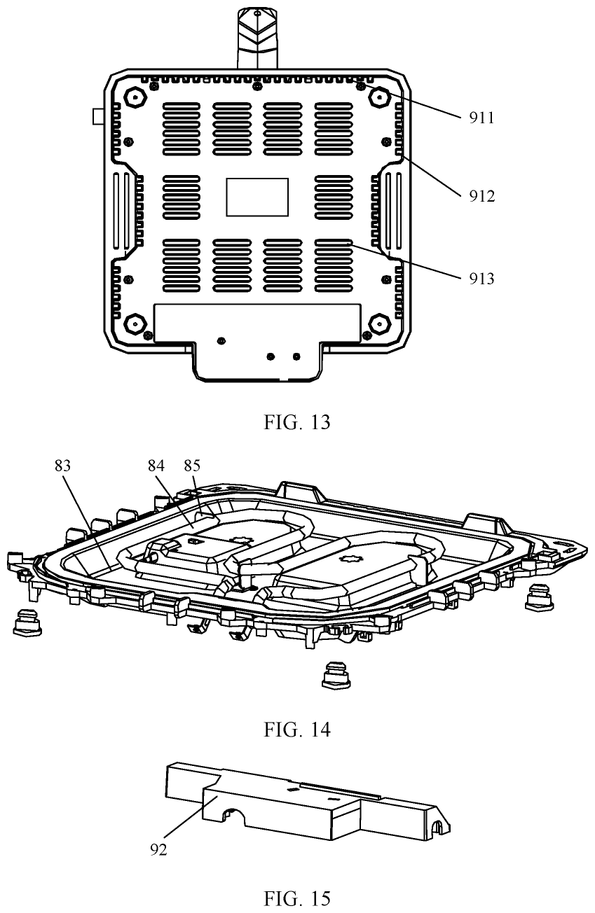

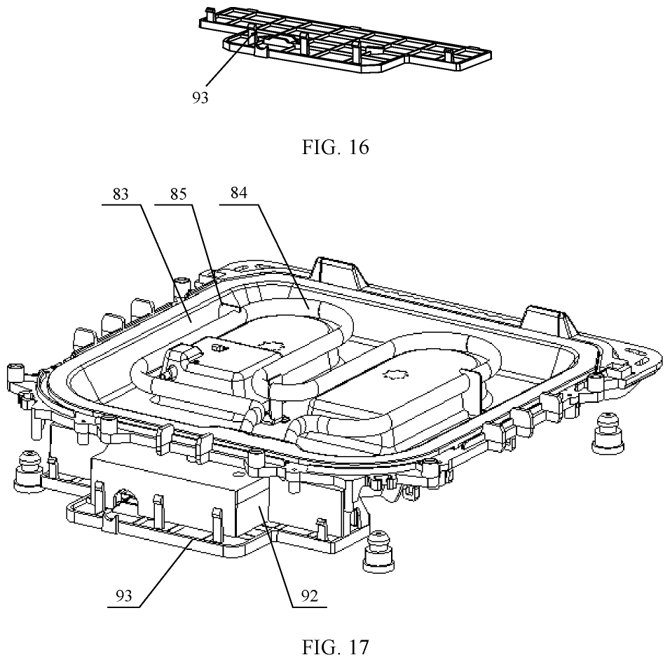

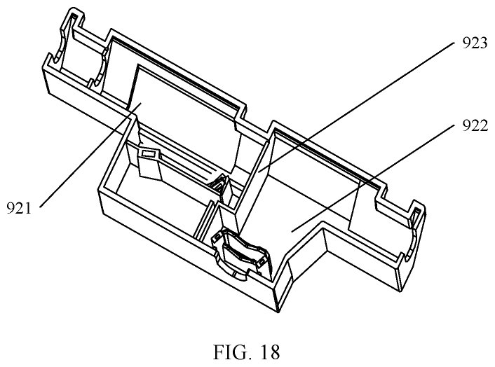

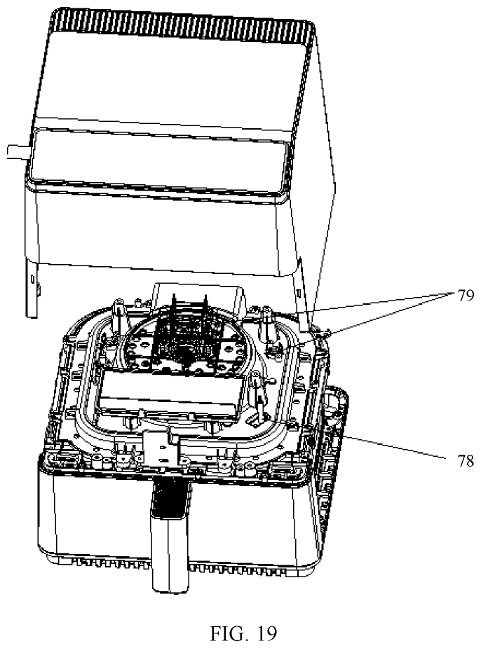

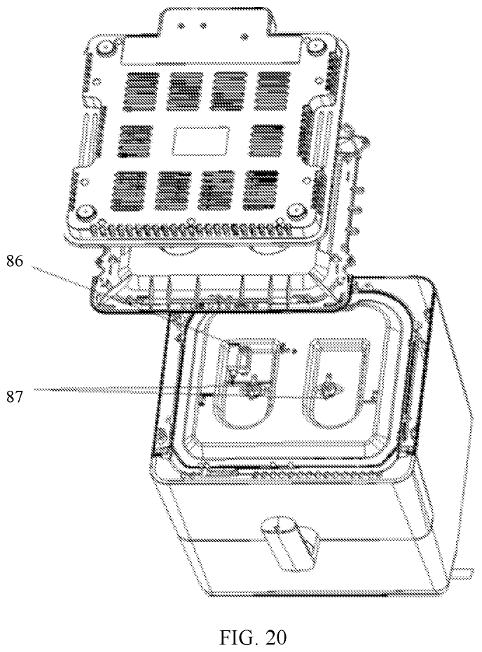

As shown in FIG. 1 to FIG. 20, an embodiment of the present invention provides an air-fried type food processor, including a body, a frying barrel 21, an upper heating system 7, and a lower heating system 8. The body is provided with a frying barrel cavity. The frying barrel 21 is capable of being taken out of or pushed into the frying barrel cavity. The upper heating system 7 is arranged in the body and located above the frying barrel cavity. The upper heating system 7 includes an upper heating tube 76 and an upper heating tube support 77 for fixing the upper heating tube 76. The upper heating tube support 77 is fixed relative to the body. The upper heating tube 76 has a disc-shaped spiral structure. The upper heating tube support 77 is located on N pipelines on outermost rings of the upper heating tube 76, and N is more than or equal to 2. The disc-shaped spiral structure is a structure formed by spirally winding the upper heating tube 76 on the same horizontal plane.

In the air-fried type food processor provided in the embodiment of the present invention, the upper heating system 7 is arranged above the frying barrel cavity, so that the upper heating system 7 heats the frying barrel 21 in the frying barrel cavity to form a three-dimensional heating system of the air-fried type food processor, and the upper heating system 7 can cook the front of food (an upward surface of food) in the frying barrel 21. The upper heating tube 76 has the disc-shaped spiral structure. Because the outer ring structure of the upper heating tube 76 with the disc-shaped spiral structure more easily deforms downward under the action of gravity, the upper heating tube support 77 is located on the N pipelines on the outermost rings of the upper heating tube 76, and as N is more than or equal to 2, a function of correspondingly binding the N pipelines on the outermost rings is achieved, thereby reducing a degree of downward deformation of the outermost rings of the upper heating tube 76. Through the foregoing arrangement, deformation of a tube body of the upper heating tube 76 is effectively reduced, and the frying barrel 21 is prevented from coming into contact with the upper heating tube 76 in the process of being taken out of the frying barrel cavity or pushed into the frying barrel cavity, thereby ensuring that the air-fried type food processor is used normally. In addition, because the upper heating tube support 77 is not connected to other parts of the air-fried type food processor except for connection to the upper heating tube 76, the fixing structure of the upper heating tube support 77 is simplified, making the installation more convenient.

The disc-shaped spiral structure is a structure formed by spirally winding the upper heating tube 76 on the same horizontal plane. The upper heating tube 76 may be wound in such a way that a single pipeline of a single upper heating tube 76 is wound, or a plurality of (for example, two) pipelines of the upper heating tube 76 are wound.

Further, the air-fried type food processor provided in the embodiment of the present invention further includes a lower heating system 8 arranged in the body and located below the frying barrel cavity, where the lower heating system 8 includes a lower heating tube 84 and a lower heating tube support 85 fixed to the lower heating tube 84, and the lower heating tube support 85 is fixed relative to the body.

Preferably, through the foregoing arrangement, the lower heating system 8 is arranged below the frying barrel cavity. The lower heating system 8 can cook a reverse side of the food (a downward surface of the food) in the frying barrel 21, and the lower heating system 8 can compensate for uneven temperature distribution of the upper heating system 7 on the food. Through the combined action of the upper heating system 7 and the lower heating system 8, the temperature of the whole space in the frying barrel 21 can be more uniform, and the problem that the middle of the food is undercooked middle and the periphery of the food is overcooked during cooking is resolved. In addition, because the upper heating system 7 and the lower heating system 8 cook the front and the reverse side of the food simultaneously, an operation of food turning and shaking by a user during cooking is avoided, which facilitates cooking by the user. Cooking the front and the reverse side of food simultaneously can shorten the cooking time. In addition, the lower heating tube support 85 supports the lower heating tube 84, which also reduces deformation of the lower heating tube 84. In addition, through the foregoing arrangement, deformation of a tube body of the lower heating tube 84 is effectively reduced, and the frying barrel 21 is prevented from coming into contact with the lower heating tube 84 in the process of being taken out of the frying barrel cavity or pushed into the frying barrel cavity, thereby ensuring that the air-fried type food processor is used normally.

The lower heating system 8 is arranged in the body and located below the frying barrel cavity. The lower heating system 8 includes a lower heating tube 84 and a lower heating tube support 85, and the lower heating tube support 85 is fixed relative to the body.

In the air-fried type food processor provided in the embodiment of the present invention, a plurality of upper heating tube supports 77 may be provided, and are arranged in a circumferential direction of the upper heating tube 76. In this embodiment, the plurality of upper heating tube supports 77 may be uniformly arranged in the circumferential direction of the upper heating tube 76, or distributed at a certain interval, which is not specifically limited herein and falls within the protection scope.

The arrangement of the upper heating tube supports 77 depends on an actual demand, and no specific limitation is imposed herein.

As shown in FIG. 7, to facilitate the installation of the upper heating tube 76, the upper heating tube support 77 includes an upper-heating-tube-support tube holder 771 and an upper-heating-tube-support tube buckle 772. The upper-heating-tube-support tube buckle 772 is capable of being bent relative to the upper-heating-tube-support tube holder 771 to form a positioning space for positioning the upper heating tube 76. The upper heating tube 76 is effectively supported through the matching between the upper-heating-tube-support tube buckle 772 and the upper-heating-tube-support tube holder 771, thereby reducing a degree of downward deformation of the tube body of the upper heating tube 76 under the action of heat and gravity. In this embodiment, the upper-heating-tube-support tube buckle 772 is a bendable extension arm, and the structure thereof may be a strip-shaped structure or other structures, which is not specifically limited herein and falls within the protection scope.

Certainly, the upper heating tube support 77 may alternatively be provided as other structures, such as a buckle or a hoop, which is not described in detail herein and falls within the protection scope.

Further, the upper heating tube support 77 is located on two pipelines on outermost rings of the upper heating tube 76; the upper-heating-tube-support tube holder 771 has two mutually independent support positions 7711; and the upper heating tube support 77 is provided with two independently arranged upper-heating-tube-support tube buckles 772, where one of the support positions 7711 is arranged corresponding to one of the upper-heating-tube-support tube buckles 772, and the other support position 7711 is arranged corresponding to the other upper-heating-tube-support tube buckle 772. Through the foregoing arrangement, the two pipelines on the outermost rings of the upper heating tube 76 are relatively positioned, and a distance between the two pipelines on the outermost rings of the upper heating tube 76 is ensured on the basis of achieving the supporting effect of the two pipelines on the outermost rings of the upper heating tube 76. In this embodiment, the supporting positions 7711 each have a groove structure, that is, the upper-heating-tube-support tube holder 771 has two mutually independent groove structures, so that the two pipelines of the outermost two rings are arranged in the two groove structures respectively, to achieve the function of limiting the distance between the two pipelines on the outermost rings, further improve the positioning effect, and further improve the supporting function of the upper heating tube support 77.

Certainly, the upper heating tube support 77 may alternatively support only one pipeline or at least three pipelines on outermost rings of the upper heating tube 76, which is not specifically limited herein and falls within the protection scope. The support positions 7711 on the upper-heating-tube-support tube holder 771 may be adjusted according to an actual demand. For example, when the upper heating tube support 77 supports three pipelines on the outermost rings of the upper heating tube 76, three support positions 7711 on the upper-heating-tube-support tube holder 771 may be provided, so that the three pipelines are placed in the three support positions 7711 respectively. Certainly, two support positions may alternatively be provided, one pipeline is placed in one of the support positions 7711, and the other two pipelines are placed in the other support position 7711.

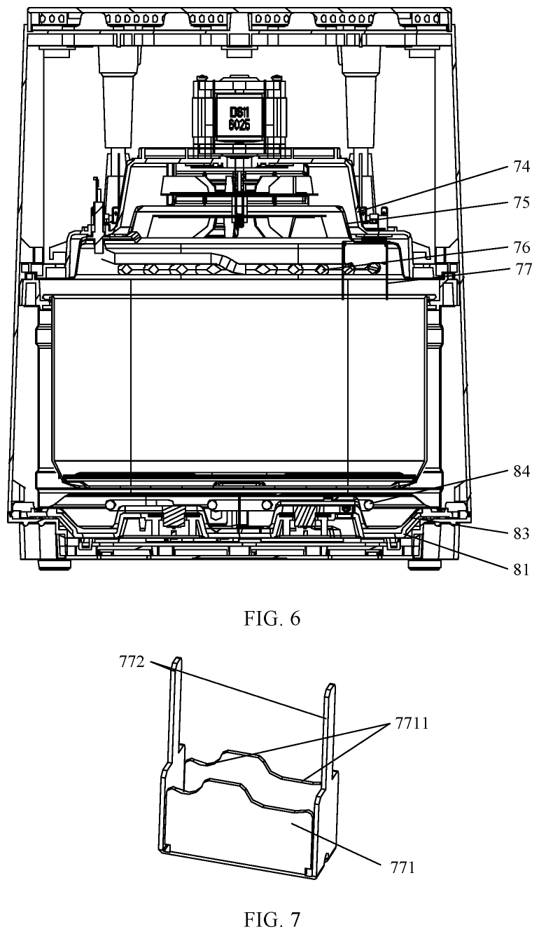

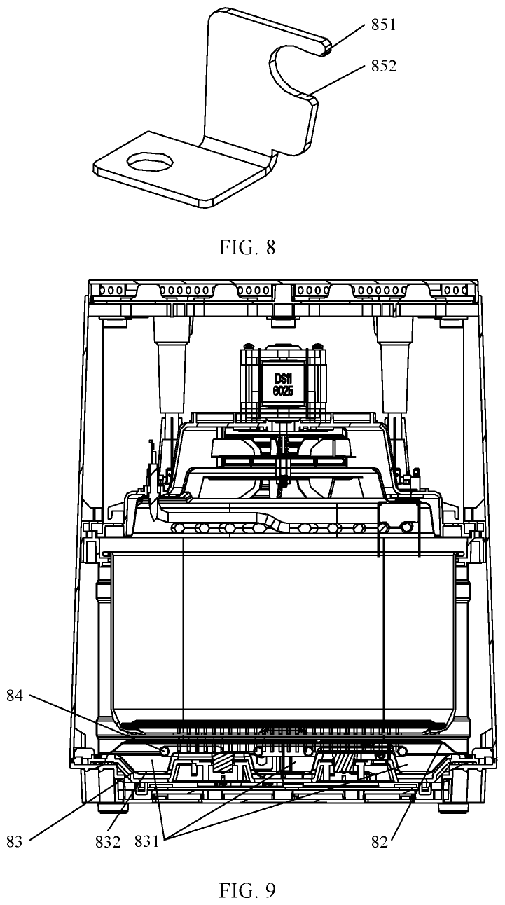

As shown in FIG. 8, to avoid upward deformation of the lower heating tube 84, the lower heating tube support 85 is provided with a lower-heating-tube-support tube buckle 851 and a lower-heating-tube-support tube holder 852. The lower-heating-tube-support tube buckle 851 and the lower-heating-tube-support tube holder 852 are correspondingly arranged. In addition, a clamping space for clamping the lower heating tube 84 is formed between the lower-heating-tube-support tube buckle 851 and the lower-heating-tube-support tube holder 852. Through the foregoing arrangement, the structure of the clamping space enables the lower-heating-tube-support tube holder 852 to provide an upward supporting force to the lower heating tube 84, and the lower-heating-tube-support tube buckle 851 achieves the function of downward limiting of the lower heating tube 84, to effectively limit upward deformation of lower heating tube 84. Through the foregoing arrangement, deformation of a tube body of the lower heating tube 84 is effectively reduced, and the frying barrel 21 is prevented from coming into contact with the lower heating tube 84 in the process of being taken out of the frying barrel cavity or pushed into the frying barrel cavity, thereby ensuring that the air-fried type food processor is used normally.

Preferably, a double U-shaped design is adopted for the lower heating tube 84, that is, the lower heating tube 84 has a W-shaped structure. Preferably, the structure of the lower heating tube 84 is located on the same horizontal plane.

Certainly, other structures may alternatively be used. Details are not described herein. Certainly, the lower heating tube 84 may alternatively have a disc-shaped spiral structure, that is, a structure formed by spirally winding the lower heating tube 84 on the same horizontal plane.

To facilitate installation, the lower heating tube support 85 is provided with a limiting opening portion; an opening of the limiting opening portion faces a side edge of the lower heating tube support 85; an upper inner wall of the limiting opening portion forms a tube buckle contact surface of the lower-heating-tube-support tube buckle 851 for being in contact with the lower heating tube 84, and a lower inner wall of the limiting opening portion forms a tube holder contact surface of the lower-heating-tube-support tube holder 852 for being in contact with the lower heating tube 84. Because the opening of the limiting opening portion faces the side edge of the lower heating tube support 85, it is convenient to install the lower heating tube 84 in the limiting opening portion. In this embodiment, an opening size of the limiting opening portion may be smaller than a size of the lower heating tube 84, and the lower heating tube 84 is installed inside the limiting opening portion by deforming the opening for installing the lower heating tube 84 in the limiting opening portion.

Certainly, the lower heating tube support 85 may alternatively be provided as a buckle, a hoop, or the like. Certainly, other support structures may alternatively be used. Details are not described herein.

The lower heating system 8 further includes a protective mesh 82 arranged above the lower heating tube 84. The protective mesh 82 is provided with a protective-mesh protection region 821 and a protective-mesh ventilation region 822, where the protective-mesh protection region 821 forms a solid shielding region corresponding to one or more pipelines of the lower heating tube 84, and the protective-mesh ventilation region 822 is provided with a vent. The protective mesh 82 is arranged above the lower heating tube 84, and is connected to the body to form a structure closed above the lower heating tube 84. Because the protective-mesh protection region 821 forms the solid shielding region corresponding to the one or more pipelines of the lower heating tube 84, the protective-mesh protection region 821 shields the lower heating tube 84, to effectively prevent a liquid and dust entering the frying barrel cavity from falling to the lower heating tube 84. The liquid that enters the frying barrel cavity includes water drops and the like carried by the frying barrel 21 when the user cleans up the frying barrel 21 and puts the same into the frying barrel cavity. The protective-mesh protection region 821 protects the lower heating tube 84, ensures the service life of the lower heating tube 84, and reduces a risk of explosion of the lower heating tube 84. In addition, the protective-mesh ventilation region 822 is provided with the vent, so that heat emitted by the lower heating tube 84 can rise to the frying barrel 21 through the vent, ensuring the heat conduction effect.

In the air-fried type food processor provided in the embodiment of the present invention, the protective mesh 82 is provided with the protective-mesh protection region 821 and the protective-mesh ventilation region 822, where the protective-mesh ventilation region 822 is provided with an open hole structure. The structure of the protective-mesh protection region 821 depends on the specific structure of the lower heating tube 84, and no specific limitation is imposed herein. Open holes in the protective-mesh ventilation region 822 may be strip-shaped holes or other open holes, and the specific open hole structure depends on an actual demand. In this embodiment, the protective-mesh protection region 821 and the protective-mesh ventilation region 822 have an integrated structure, and the protective-mesh protection region 821 protrudes from the protective-mesh ventilation region 822 so as to reserve more space below the protective-mesh protection region 821, to achieve the chimney effect.

Further, the lower heating system 8 further includes a lower reflecting cover 83 arranged below the lower heating tube 84; the lower reflecting cover 83 is provided with a concave structure 832 which is arranged corresponding to the one or more pipelines of the lower heating tube 84, and a lower-reflecting-cover concave reflecting region 831 for radiating heat of the lower heating tube 84 upward is formed between an inner wall of the concave structure 832 and an inner wall of the protective mesh 82. The inner wall of the concave structure 832 is a wall surface of the concave structure 832 facing the protective mesh 82, and the inner wall of the protective mesh 82 is a wall surface of the protective mesh 82 facing the concave structure 832. Due to the design of the concave structure 832, a vertical height of the lower-reflecting-cover concave reflecting region 831 increases, and the convection above and below the protective mesh 82 is strengthened by using the chimney effect, so that the heat of the lower heating tube 84 passes through the vent in the protective mesh 82 in an accelerated manner and is transferred to the bottom of the frying barrel 21 for heating, and the reverse side of the food is heated, cooking the food more quickly without turning or shaking. Through the foregoing arrangement, the front and the reverse side of the food are cooked simultaneously, an operation of food turning and shaking by a user during cooking is avoided, which facilitates cooking by the user. Cooking the front and the reverse side of food simultaneously can shorten the cooking time.

To further strengthen the convection above and below the protective mesh 82, the protective mesh 82 is provided with a protective plate body 820 located in the middle and an inclined connecting plate 823 located at an edge of the protective plate body 820; the inclined connecting plate 823 is inclined toward a side on which the lower heating tube 84 is located; and in addition, the inclined connecting plate 823 is inclined downward in a direction away from the protective plate body 820. Through the foregoing arrangement, a longitudinal section of the reinforced protective mesh 82 is designed as a trapezoidal structure. In addition, the trapezoidal structure is a structure with a small top and a large bottom, which is more conducive to the use of the chimney effect to strengthen the convection above and below the protective mesh 82. That is, through the foregoing arrangement, a vertical height of the lower-reflecting-cover concave reflecting region 831 increases, and the convection above and below the protective mesh 82 is strengthened by using the chimney effect, so that the heat of the lower heating tube 84 passes through the vent in the protective mesh 82 in an accelerated manner and is transferred to the bottom of the frying barrel 21 for heating, and the reverse side of the food is heated, cooking the food more quickly without turning or shaking. It may be understood that both the protective-mesh protection region 821 and the protective-mesh ventilation region 822 are located on the protective plate body 820.

In this embodiment, the lower heating system 8 further includes a lower cover body structure, where the lower cover body structure is fixedly connected to the inside of the body; the lower cover body structure includes a lower reflecting cover 83 and a lower heat shield 81 arranged on a side of the lower reflecting cover 83 away from the lower heating tube 84, and the lower heating tube support 85 is fixedly connected to the lower cover body structure.

Preferably, in the air-fried type food processor provided in the embodiment of the present invention, a thermal conductivity of the lower heat shield 81 is lower than a thermal conductivity of the lower reflecting cover 83. Due to the combined structure of the lower reflecting cover 83 and the lower heat shield 81, the lower cover body structure is a double-layer heat insulation structure. The thermal conductivity of the lower heat shield 81 is lower than the thermal conductivity of the lower reflecting cover 83, which can effectively isolate the heat above the lower reflecting cover 83, that is, inside the frying barrel cavity, so as to better lock the heat inside the frying barrel 21, improve thermal efficiency of the whole machine, effectively shorten a food cooking time, and make the food more delicious. Certainly, the lower heating tube support 85 may alternatively be directly fixed to a housing 1 of the body.

In this embodiment, to prolong the service life, the lower reflecting cover 83 is a metal cover; and the lower heat shield 81 is a plastic heat shield. Certainly, the lower reflecting cover 83 and the lower heat shield 81 may alternatively be made of other materials, such as high-temperature-resistant glass or ceramics, which is not specifically limited herein and falls within the protection scope.

Similarly, the upper heating system 7 further includes an upper cover body structure, where the upper cover body structure is fixedly connected to the inside of the body; the upper cover body structure includes an upper reflecting cover 75 covering above the upper heating tube 76 and an upper heat shield 74 arranged on a side of the upper reflecting cover 75 away from the upper heating tube 76; and a thermal conductivity of the upper heat shield 74 is lower than a thermal conductivity of the upper reflecting cover 75. Due to the combined structure of the upper reflecting cover 75 and the upper heat shield 74, the upper cover body structure is a double-layer heat insulation structure. The thermal conductivity of the upper heat shield 74 is lower than the thermal conductivity of the upper reflecting cover 75, which can effectively isolate the heat below the upper reflecting cover 75, that is, inside the frying barrel cavity, so as to better lock the heat inside the frying barrel 21, improve thermal efficiency of the whole machine, effectively shorten a food cooking time, and make the food more delicious. Certainly, the upper heating tube support 77 may alternatively be directly fixed to the housing 1 of the body. In this embodiment, preferably, the upper heating tube support 77 and the upper heat shield 74 are independent of each other, that is, a relationship of interconnection exists only between the upper heating tube support 77 and the upper heating tube 76. Through the foregoing arrangement, an existing structure does not need to be changed.

Further, the upper reflecting cover 75 is a metal cover; and the upper heat shield 74 is a plastic heat shield. Certainly, the lower reflecting cover 83 and the lower heat shield 81 may alternatively be made of other materials, such as high-temperature-resistant glass or ceramics, which is not specifically limited herein and falls within the protection scope.

The air-fried type food processor provided in the embodiment of the present invention further includes a power box for being conductively connected with to the upper heating tube 76 and/or the lower heating tube 84, where the power box includes a power box bottom housing 92 and a power box cover 93; the power box bottom housing 92 is internally provided with a power-box-bottom-housing interval separation rib 923, and the power-box-bottom-housing interval separation rib 923 divides an inner cavity of the power box bottom housing 92 into a power-box-bottom-housing heating tube terminal region 921 for placing a heating tube terminal and a power-box-bottom-housing power wire region 922 for placing a power wire; and after the power box cover 93 covers the power box bottom housing 92, the power-box-bottom-housing heating tube terminal region 921 and the power-box-bottom-housing power wire region 922 are independent of each other. Through mutual independence of the heating tube terminal and the power wire, the protection for the terminal of the heating tube is effectively improved.

In particular, the terminal of the lower heating tube 84 is a terminal connected to a strong current, and therefore, the power wire arranged corresponding to the terminal is a power wire for supplying the strong current, which is prone to fire risk. Through the foregoing arrangement, a circuit is effectively protected.

In this embodiment, the power box is connected to the lower heating tube 84. The power box includes a power box bottom housing 92 and a power box cover 93; the power box bottom housing 92 is internally provided with a power-box-bottom-housing interval separation rib 923, and the power-box-bottom-housing interval separation rib 923 divides an inner cavity of the power box bottom housing 92 into a power-box-bottom-housing heating tube terminal region 921 for placing a heating tube terminal of the lower heating tube 84 and a power-box-bottom-housing power wire region 922 for placing a power wire; and after the power box cover 93 covers the power box bottom housing 92, the power-box-bottom-housing heating tube terminal region 921 and the power-box-bottom-housing power wire region 922 are independent of each other. Through the foregoing arrangement, the heating tube terminal of the lower heating tube 84 and the power wire are independent of each other.

Certainly, the power box may alternatively be connected to the upper heating tube 76. The power box includes a power box bottom housing 92 and a power box cover 93; the power box bottom housing 92 is internally provided with a power-box-bottom-housing interval separation rib 923, and the power-box-bottom-housing interval separation rib 923 divides an inner cavity of the power box bottom housing 92 into a power-box-bottom-housing heating tube terminal region 921 for placing a heating tube terminal of the upper heating tube 76 and a power-box-bottom-housing power wire region 922 for placing a power wire; and after the power box cover 93 covers the power box bottom housing 92, the power-box-bottom-housing heating tube terminal region 921 and the power-box-bottom-housing power wire region 922 are independent of each other. Through the foregoing arrangement, the heating tube terminal of the upper heating tube 76 and the power wire are independent of each other.

The power box may alternatively be connected to the upper heating tube 76 and the lower heating tube 84. The power box includes a power box bottom housing 92 and a power box cover 93; the power box bottom housing 92 is internally provided with a power-box-bottom-housing interval separation rib 923, and the power-box-bottom-housing interval separation rib 923 divides an inner cavity of the power box bottom housing 92 into a power-box-bottom-housing heating tube terminal region 921 for placing heating tube terminals of both the upper heating tube 76 and the lower heating tube 84 and a power-box-bottom-housing power wire region 922 for placing a power wire; and after the power box cover 93 covers the power box bottom housing 92, the power-box-bottom-housing heating tube terminal region 921 and the power-box-bottom-housing power wire region 922 are independent of each other. Through the foregoing arrangement, the heating tube terminals of both the upper heating tube 76 and the lower heating tube 84 and the power wire are independent of each other.

In this embodiment, one power box may be provided, and is connected to the upper heating tube 76 and the lower heating tube 84. Two power boxes may alternatively be provided. One of the power boxes is connected to the upper heating tube 76, and the other power box is connected to the lower heating tube 84. A specific arrangement is not limited and falls within the protection scope.

The power box bottom housing 92 and the power box cover 93 are made of a fireproof material. In addition, after the power box cover 93 covers the power box bottom housing 92, a closed fireproof cavity is formed inside, and can effectively prevent flame spread caused by a fire occurring to the terminal. The specific fireproof material of the power box bottom housing 92 and the power box cover 93 is not required, as long as the material can achieve an effective fireproof effect.

Further, the power box is made of a fireproof material. Through the foregoing arrangement, the power box can prevent fire, and makes the use safer. A fireproof layer may alternatively be additionally provided on the power box by means such as coating or spraying, which is not specifically described herein and falls within the protection scope.

In the air-fried type food processor provided in the embodiment of the present invention, the upper heating system 7 further includes an upper temperature sensor 78 and an upper temperature protector 79 for protecting a zero line/live line of the upper heating system 7; the upper temperature sensor 78 is in communication connection with the upper heating tube 76, and a heating temperature of the upper heating tube 76 is controlled according to a temperature detected by the upper temperature sensor 78. Through the foregoing arrangement, the upper heating system 7 can independently control the temperature, further improving the cooking effect. In addition, through the arrangement of the temperature protector, a zero line/live line of the heating tube is controlled, so that a fire caused by a failure of temperature control is prevented, making the use safer. One or more upper temperature protectors 79 may be provided. In an embodiment in which a plurality of lower heating tubes 84 are connected, an arrangement of lower temperature protectors 87 can be determined according to an actual demand, and details are not described herein.

Further, the lower heating system 8 further includes a lower temperature sensor 86 and a lower temperature protector 87 for protecting a zero line/live line of the lower heating system 8; the lower temperature sensor 86 is in communication connection with the lower heating tube 84, and a heating temperature of the lower heating tube 84 is controlled according to a temperature detected by the lower temperature sensor 86. Through the foregoing arrangement, the lower heating system 8 can independently control the temperature, further improving the cooking effect. In addition, through the arrangement of the temperature protector, a zero line/live line of the heating tube is controlled, so that a fire caused by a failure of temperature control is prevented, making the use safer. One or more lower temperature protectors 87 may be provided. In an embodiment in which a plurality of lower heating tubes 84 are connected, an arrangement of lower temperature protectors 87 can be determined according to an actual demand, and details are not described herein.

Through the foregoing arrangement, even if the sensor or the protector in one heating system fails, the sensor and the protector in the other heating system can also achieve the function of protecting the machine, prevent fire and ensure use safety.

Further, the body includes a housing 1, a top structure, and a bottom housing 9. The frying barrel cavity, the upper heating system 7, and the lower heating system 8 are all located in the housing 1, and an outer wall of the housing 1 is provided with an opening for the frying barrel 21 to be taken out of or pushed into the frying barrel cavity. The top structure is arranged above the housing 1 and includes a panel 4 and a top cover 5. The bottom housing 9 is arranged below the housing 1.

It may be understood that the panel 4 may be a control panel, and the panel 4 is provided with corresponding buttons, a display and other components.

In the air-fried type food processor provided in the embodiment of the present invention, the upper heating system 7 is arranged above the frying barrel cavity, and the lower heating system 8 is arranged below the frying barrel cavity. The upper heating system 7 and the lower heating system 8 are combined to form the three-dimensional heating system of the air-fried type food processor. The upper heating system 7 can cook the front of food (an upward surface of food) in the frying barrel 21. The lower heating system 8 can cook a reverse side of the food (a downward surface of the food) in the frying barrel 21, and the lower heating system 8 can compensate for uneven temperature distribution of the upper heating system 7 on the food. Through the combined action of the upper heating system 7 and the lower heating system 8, the temperature of the whole space in the frying barrel 21 can be more uniform, and the problem that the middle of the food is undercooked middle and the periphery of the food is overcooked during cooking is resolved. In addition, because the upper heating system 7 and the lower heating system 8 cook the front and the reverse side of the food simultaneously, an operation of food turning and shaking by a user during cooking is avoided, which facilitates cooking by the user. Cooking the front and the reverse side of food simultaneously can shorten the cooking time. The upper heating tube 76 has a disc-shaped spiral structure. Because an outer ring structure of the upper heating tube 76 with a vortex structure more easily deforms downward under the action of gravity, the upper heating tube support 77 is located on N pipelines on outermost rings of the upper heating tube 76, so as to reduce downward deformation of the upper heating tube 76. In addition, the lower heating tube support 85 supports the lower heating tube 84, which also reduces the deformation of the lower heating tube 84. Through the foregoing arrangement, deformation of a tube body of the heating tube is effectively reduced, and the frying barrel 21 is prevented from coming into contact with the heating tube (the upper heating tube 76 and the lower heating tube 84) in the process of being taken out of the frying barrel cavity or pushed into the frying barrel cavity, thereby ensuring that the air-fried type food processor is used normally.

In a specific embodiment, the air-fried type food processor includes a housing 1, a door 2, a handle 3, a panel 4, a top cover 5, an air inlet 6, an upper heating system 7, a lower heating system 8, and a bottom housing 9.

The top cover 5 is arranged at the top of the housing 1 and connected to the housing 1 by using a screw or a snap joint, the panel 4 is arranged in front of the top of the top cover 5, and the panel 4 is connected to the top cover 5 by using a screw or a snap joint. The upper heating system 7 is arranged inside the housing 1 and at the top, and the lower heating system 8 is arranged inside the housing 1 and at the bottom. The bottom housing 9 is arranged at the bottom of the housing 1. The bottom housing 9 is connected to the housing 1 by using a screw or a snap joint.

The upper reflecting cover 75 is arranged inside the housing 1 and above the door 2. The upper reflecting cover 75 is connected to the housing 1 by using a screw or a snap joint. The upper heat shield 74 is arranged above the upper reflecting cover 75. The upper heat shield 74 is connected to the upper reflecting cover 74 by using a screw.

Preferably, the power box of the air-fried type food processor is arranged in the bottom housing 9.

The air-fried type food processor provided in the embodiment of the present invention further includes a door 2 arranged on a side of the frying barrel 21 and a handle 3 arranged on the door 2. The door 2 can close the opening after the frying barrel 21 is pushed into the frying barrel cavity. In this embodiment, the door 2 is arranged above the frying barrel 21 and can be pushed or pulled at any time, and the handle 3 is arranged outside the door 2. The handle 3 is connected to the door 2 by using a screw or a snap joint. The frying barrel 21 may be arranged between the upper heating system 7 and the lower heating system 8. The frying barrel 21 is connected to the door 2 by using a screw. The frying barrel 21 and the door 2 can be pulled out of or placed into the frying barrel cavity by using the handle 3.

Further, in the air-fried type food processor provided in the embodiment of the present invention, the housing 1 is provided with a first air inlet and outlet 6 and a second air inlet and outlet 11; the bottom housing 9 is provided with a bottom housing vent 91; and the top cover 5 is provided with a top cover air inlet and outlet 51. Air flow is achieved by using the foregoing air inlets and outlets and vent, which achieves the function of temperature control. The first air inlet and outlet 6 is arranged at the rear of the top of the housing 1, and is connected to the housing 1 by using a screw or a snap joint. The second air inlet and outlet 11 is arranged at the back of the housing 1. The top cover air inlet and outlet 51 is arranged at the back of the top cover 5. The back of the top cover 5 and the back of the housing 1 are only parts of the air-fried type food processor that face away from an operator. The opening of the frying barrel cavity is located on a part of the housing 1 facing the operator.

The upper heating system 7 includes a motor 71, an air guide apparatus (cooling fan blades 72 and stirring fan blades 73), an upper heat shield 74, an upper reflecting cover 75, an upper heating tube 76, and an upper heating tube support 77.

A driving motor 71 is arranged above the upper heat shield 74. The driving motor 71 is connected to the upper heat shield 74 by using a screw. The cooling fan blades 72 are arranged below the upper heat shield 74 and above the upper reflecting cover 75. A motor shaft of the driving motor 71 drives the cooling fan blades 72 to rotate, and the stirring fan blades 73 are arranged below the upper reflecting cover 75 and driven by the motor shaft of the driving motor 71 to rotate. The upper heating tube 76 is arranged below the upper reflecting cover 75. The upper reflecting cover 75 is connected to the upper heat shield 74 by using a screw, and the upper heating tube support 77 is arranged between the upper reflecting cover 75 and the upper heating tube 76. The upper heating tube support 77 is connected to the upper heat shield 74 by using a screw. The upper heating tube support 77 is connected to the upper heating tube 76.

The lower heating system 8 includes a lower heat shield 81, a protective mesh 82, a lower reflecting cover 83, a lower heating tube 84, and a lower heating tube support 85.

The lower heat shield 81 is arranged above the bottom housing 9. The lower heat shield 81 is connected to the housing 1 and the bottom housing 9 by using screws or snap joints. The lower reflecting cover 83 is arranged above the lower heat shield 81. The lower reflecting cover 83 is connected to the lower heat shield 81 by using a screw or a snap joint, and the lower heating tube 84 is arranged above the lower reflecting cover 83. The lower reflecting cover 83 is connected to the lower heat shield 81 by using a screw, and the lower heating tube support 85 is arranged between the lower reflecting cover 83 and the lower heating tube 84. The lower heating tube support 85 is connected to the lower heat shield 81 by using a screw. In addition, the lower heating tube support 85 positions and is connected to the lower heating tube 84, the protective mesh 82 is arranged above the lower heating tube 84, and the protective mesh 82 is connected to the lower heat shield 81 by using a screw or a snap joint.

To further cool the door 2 and facilitate an operation of taking out and placing the frying barrel 21, a door cooling channel is provided in the door 2 of the air-fried type food processor. The door cooling channel is provided with an upper door vent 22 and a lower door vent 23, and the upper door vent 22 and the lower door vent 23 communicate with a cold air duct.

Because the user may cook different foods by using the air-fried type food processor, when different foods are cooked, a cooking temperature and a rotating speed of the air guide apparatus are also different. In addition to setting of a specific temperature and air guide efficiency of the air guide apparatus (such as a fan blade speed), when the user cooks vegetables on some menus, the temperature and the air guide efficiency change according to program settings. The user does not need to turn or shake food, thereby improving efficiency.

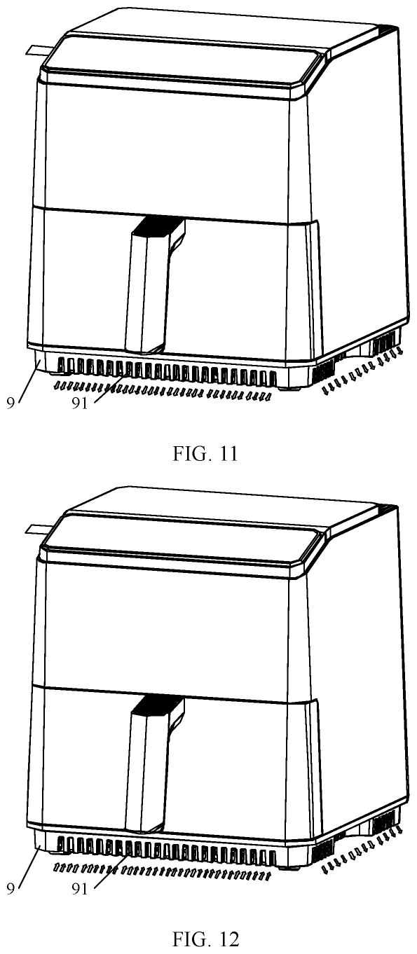

As shown in FIG. 11, FIG. 12 and FIG. 13, to improve the bottom cooling effect of the air-fried type food processor, the bottom housing vent 91 includes a front vent 911, side vents 912 on a left side and a right side, and a bottom vent 913 at the bottom. The bottom vent 913 is configured to cool the lower heat shield 81 of the lower heating system 8. The front vent 911 is an air inlet and side vents 912 are air outlets; or the front vent 911 is an air outlet and side vents 912 are air inlets. Air inlet and outlet directions of the foregoing vents may alternatively be of other types. Because air flowing through the air duct from the vent is cold air, temperatures of internal devices such as the heating tube and the door 2 and the surface of the machine can be lowered, making the use safer.

In this description, embodiments are described in a progressive manner, and the description of each embodiment focuses on differences from other embodiments. Mutual reference may be made to the same and similar parts of the embodiments.

The foregoing description of the disclosed embodiments enables a person skilled in the art to achieve or use the present invention. Multiple modifications to these embodiments are obvious to a person skilled in the art, and general principles defined herein may be implemented in other embodiments without departing from the spirit or scope of the present invention. Therefore, the present invention is not limited to the embodiments shown herein, but should accord with the widest scope consistent with the principles and novel features disclosed herein.

What is claimed is:

1. An air-fried type food processor, comprising:
a body, wherein the body is provided with a frying barrel cavity;
a frying barrel (21) capable of being taken out of or placed in the frying barrel cavity; and
an upper heating system (7) arranged in the body and located above the frying barrel cavity, wherein the upper heating system (7) comprises an upper heating tube (76) and an upper heating tube support (77) for fixing the upper heating tube (76), wherein the upper heating tube (76) has a disc-shaped spiral structure, the upper heating tube support (77) is fixed to N pipelines on outermost rings of the upper heating tube (76), and N is more than or equal to 2.

2. The air-fried type food processor according to claim 1, further comprising a lower heating system (8) arranged in the body and located below the frying barrel cavity, wherein the lower heating system (8) comprises a lower heating tube (84) and a lower heating tube support (85) fixed to the lower heating tube (84), and the lower heating tube support (85) is fixed relative to the body.

3. The air-fried type food processor according to claim 1, wherein the upper heating tube support (77) comprises an upper-heating-tube-support tube holder (771) and an upper-heating-tube-support tube buckle (772); and
the upper-heating-tube-support tube buckle (772) is capable of being bent relative to the upper-heating-tube-support tube holder (771) to form a positioning space for positioning the upper heating tube (76).

4. The air-fried type food processor according to claim 3, wherein the upper heating tube support (77) is located on two pipelines on the outermost rings of the upper heating tube (76);
the upper-heating-tube-support tube holder (771) has two mutually independent support positions (7711); and
the upper heating tube support (77) is provided with two independently arranged upper-heating-tube-support tube buckles (772),
wherein one of the support positions (7711) is arranged corresponding to one of the upper-heating-tube-support tube buckles (772), and the other support position (7711) is arranged corresponding to the other upper-heating-tube-support tube buckle (772).

5. The air-fried type food processor according to claim 2, wherein the lower heating tube support (85) is provided with a lower-heating-tube-support tube buckle (851) and a lower-heating-tube-support tube holder (852); and
the lower-heating-tube-support tube buckle (851) and the lower-heating-tube-support tube holder (852) are correspondingly arranged, and a clamping space for clamping the lower heating tube (84) is formed between the lower-heating-tube-support tube buckle (851) and the lower-heating-tube-support tube holder (852).

6. The air-fried type food processor according to claim 5, wherein the lower heating tube support (85) is provided with a limiting opening portion;
an opening of the limiting opening portion faces a side edge of the lower heating tube support (85); and
an upper inner wall of the limiting opening portion forms a tube buckle contact surface of the lower-heating-tube-support tube buckle (851) for being in contact with the lower heating tube (84), and a lower inner wall of the limiting opening portion forms a tube holder contact surface of the lower-heating-tube-support tube holder (852) for being in contact with the lower heating tube (84).

7. The air-fried type food processor according to claim 2, wherein the lower heating system (8) further comprises a protective mesh (82) arranged above the lower heating tube (84); and
the protective mesh (82) is provided with a protective-mesh protection region (821) and a protective-mesh ventilation region (822), wherein the protective-mesh protection region (821) forms a solid shielding region corresponding to one or more pipelines of the lower heating tube (84), and the protective-mesh ventilation region (822) is provided with a vent.

8. The air-fried type food processor according to claim 7, wherein the lower heating system (8) further comprises a lower reflecting cover (83) arranged below the lower heating tube (84);
the lower reflecting cover (83) is provided with a concave structure (832) which is arranged corresponding to the one or more pipelines of the lower heating tube (84), and a lower-reflecting-cover concave reflecting region (831) for radiating heat of the lower heating tube (84) upward is formed between an inner wall of the concave structure (832) and an inner wall of the protective mesh (82); and
the inner wall of the concave structure (832) is a wall surface of the concave structure (832) facing the protective mesh (82), and the inner wall of the protective mesh (82) is a wall surface of the protective mesh (82) facing the concave structure (832).

9. The air-fried type food processor according to claim 7, wherein the protective mesh (82) is provided with a protective plate body (820) located in the middle and an inclined connecting plate (823) located at an edge of the protective plate body (820); and
the inclined connecting plate (823) is inclined toward a side on which the lower heating tube (84) is located, and is inclined downward in a direction away from the protective plate body (820).

10. The air-fried type food processor according to claim 8, wherein the lower heating system (8) further comprises a lower cover body structure fixedly connected to inside of the body; and
the lower cover body structure comprises a lower reflecting cover (83) and a lower heat shield (81) arranged on a side of the lower reflecting cover (83) away from the lower heating tube (84), and the lower heating tube support (85) is fixedly connected to the lower cover body structure.

11. The air-fried type food processor according to claim 1, wherein the upper heating system (7) further comprises an upper cover body structure fixedly connected to inside of the body;
the upper cover body structure comprises an upper reflecting cover (75) covering above the upper heating tube (76) and an upper heat shield (74) arranged on a side of the upper reflecting cover (75) away from the upper heating tube (76); and
a thermal conductivity of the upper heat shield (74) is lower than a thermal conductivity of the upper reflecting cover (75).

12. The air-fried type food processor according to claim 2, further comprising a power box for being conductively connected with the upper heating tube (76) and/or the lower heating tube (84), wherein
the power box comprises a power box bottom housing (92) and a power box cover (93);
the power box bottom housing (92) is internally provided with a power-box-bottom-housing interval separation rib (923), and the power-box-bottom-housing interval separation rib (923) divides an inner cavity of the power box bottom housing (92) into a power-box-bottom-housing heating tube terminal region (921) for placing a heating tube terminal and a power-box-bottom-housing power wire region (922) for placing a power wire; and
after the power box cover (93) covers the power box bottom housing (92), the power-box-bottom-housing heating tube terminal region (921) and the power-box-bottom-housing power wire region (922) are mutually independent.

13. The air-fried type food processor according to claim 1, wherein the upper heating system (7) further comprises an upper temperature sensor (78) and an upper temperature protector (79) for protecting a zero line/live line of the upper heating system (7); the upper temperature sensor (78) is in communication connection with the upper heating tube (76), and a heating temperature of the upper heating tube (76) is controlled according to a temperature detected by the upper temperature sensor (78).

14. The air-fried type food processor according to claim 2, wherein
the lower heating system (8) further comprises a lower temperature sensor (86) and a lower temperature protector (87) for protecting a zero line/live line of the lower heating system (8); the lower temperature sensor (86) is in communication connection with the lower heating tube (84), and a heating temperature of the lower heating tube (84) is controlled according to a temperature detected by the lower temperature sensor (86).
